(19) United States
(12) Patent Application Publication
(10) Pub. No.: US 2026/0117888 A1
(43) Pub. Date: Apr. 30, 2026

(54) FLUID DEVICE

(71) Applicant: Surpass Industry Co., Ltd., Saitama (JP)

(72) Inventors: Atsushi INOUE, Saitama (JP); Hiroki Igarashi, Saitama (JP)

(21) Appl. No.: 19/350,919

(22) Filed: Oct. 6, 2025

(30) Foreign Application Priority Data
Oct. 30, 2024 (JP) 2024-190946

(51) Int. Cl. F16K 37/00; G01K 1/14; G01K 13/02

(52) U.S. Cl. CPC F16K 37/005; G01K 1/14; G01K 13/026

(57) ABSTRACT

Provided is an isolation valve including: a valve disc; a body having a valve chamber, an inflow-side flow channel, and an outflow-side flow channel that are integrally formed of a resin material; and a temperature detecting portion configured to determine a temperature of a fluid flowing through the body, and the inflow-side flow channel has a first flow channel part extending along a first axis and a second flow channel part extending along a second axis that intersects the first axis, the first flow channel part and the second flow channel part are coupled to each other in a coupling region, a protruding part protruding along the first axis from an inner circumferential face of the coupling region is formed in the body, and an accommodation hole accommodating the temperature detecting portion is formed inside the protruding part.

### CROSS-REFERENCE TO RELATED APPLICATIONS

This application claims foreign priority benefits under U.S.C. § 119 to Japanese Patent Application No. 2024-190946 filed on Oct. 30, 2024, the contents of which is hereby incorporated by reference in its entirety.

### BACKGROUND

### 1. Technical Field

The present disclosure relates to a fluid device.

### 2. Description of Related Art

Isolation valves installed to a pipe through which a fluid (a liquid such as a chemical solution and pure water) used in semiconductor manufacturing apparatuses or the like flows are conventionally known (see, for example, Japanese Patent Application Laid-Open No. 2015-215028). In the isolation valve disclosed in Japanese Patent Application Laid-Open No. 2015-215028, a valve chamber, an inflow-side flow channel, and an outflow-side flow channel are integrally formed of a fluororesin material.

In a fluid device such as an isolation valve, it may be required to suitably determine the temperature of a fluid flowing through therein. When the fluid flowing through inside the fluid device is a corrosive chemical solution or the like, although the temperature of the fluid can be suitably determined, a temperature detecting portion may come into direct contact with the fluid and cause corrosion or the like when the temperature detecting portion is arranged inside the flow channel through which the fluid flows. Thus, it is not suitable to arrange the temperature detecting portion inside the flow channel through which the fluid flows.

To prevent the temperature detecting portion from being in direct contact with the fluid, one possible method is, for example, to embed a temperature detecting portion in a portion near the inner circumferential face of the flow channel through which the fluid flows and use the temperature detecting portion to determine the temperature transferred from a resin material forming the flow channel.

However, when the temperature detecting portion is positioned close to the inner circumferential face of the flow channel for suitable determination of the temperature of the fluid, the resin material portion will be thin, and there is a risk of damage of the resin material. Further, when a difference in the temperature of the fluid occurs between a portion near the inner circumferential face of the flow channel and the center of the flow channel, it is not possible to suitably determine the temperature of the fluid flowing through the center of the flow channel.

### SUMMARY

The present disclosure has been made in view of such circumstances and intends to provide a fluid device that can suitably determine the temperature of a fluid flowing through the center of a flow channel without direct contact of a temperature detecting portion with the fluid.

The present disclosure employs the following solutions in order to solve the above problem.

A fluid device according to one aspect of the present disclosure includes: a valve disc formed in a shaft-like shape extending along a motion axis and configured to be movable along the motion axis; a body having a valve chamber, an inflow-side flow channel, and an outflow-side flow channel that are integrally formed of a resin material, the valve chamber accommodating the valve disc, the inflow-side flow channel being configured to guide a fluid flowing from an inflow-side pipe to the valve chamber, and the outflow-side flow channel being configured to guide a fluid from the valve chamber to an outflow-side pipe; and a temperature detecting portion configured to determine a temperature of a fluid flowing through the body, and one of the inflow-side flow channel and the outflow-side flow channel has a first flow channel part extending along a first axis with one end communicating with the valve chamber and a second flow channel part extending along a second axis that intersects the first axis with one end communicating with one of the inflow-side pipe and the outflow-side pipe, the first flow channel part and the second flow channel part are coupled to each other in a coupling region, a protruding part protruding along the first axis or the second axis from an inner circumferential face of the coupling region is formed in the body, and an accommodation hole accommodating the temperature detecting portion is formed inside the protruding part.

The fluid device according to one aspect of the present disclosure includes: a body having a valve chamber, an inflow-side flow channel, and an outflow-side flow channel that are integrally formed of a resin material. One of the inflow-side flow channel and the outflow-side flow channel has a first flow channel part extending along a first axis and a second flow channel part extending along a second axis that intersects the first axis. A protruding part protruding along the first axis or the second axis from an inner circumferential face of the coupling region in which the first flow channel part and the second flow channel part are coupled to each other is formed in the body. Further, the temperature detecting portion is accommodated in the accommodation hole formed inside the protruding part.

According to the fluid device of one aspect of the present disclosure, since the temperature detecting portion is accommodated inside the protruding part, the damage of the temperature detecting portion that would otherwise be caused by direct contact of the temperature detecting portion with the fluid can be inhibited. Further, since the protruding part in which the temperature detecting portion is accommodated protrudes along the first axis or the second axis from the inner circumferential face of the coupling region, the temperature of a fluid flowing through the center of the first flow channel part or the second flow channel part can be suitably determined.

In the fluid device according to one aspect of the present disclosure, a preferable configuration is such that the protruding part is formed in a circular cylindrical shape protruding along the first axis from the inner circumferential face of the coupling region, and an outer diameter of the protruding part is set to be greater than or equal to 0.1 times and less than or equal to 0.8 times a first inner diameter of the first flow channel part.

According to the fluid device of the above configuration, by setting the outer diameter of the protruding part to be greater than or equal to 0.1 times the first inner diameter of the first flow channel part, it is possible to sufficiently secure the inner diameter of the accommodation hole that accommodates the temperature detecting portion inside the protruding part. Further, by setting the outer diameter of the protruding part to be less than or equal to 0.8 times the first inner diameter of the first flow channel part, it is possible to prevent the protruding part from excessively inhibiting the flow of a fluid in the first flow channel part and the second flow channel part.

In the fluid device of the above configuration, a preferable form is such that a length along the first axis of the protruding part is set to be greater than or equal to 0.1 times and less than or equal to 0.5 times a second inner diameter of the second flow channel part.

According to the fluid device of the above form, by setting the length along the first axis of the protruding part to be greater than or equal to 0.1 times the second inner diameter of the second flow channel part, it is possible to sufficiently secure the length of the accommodation hole that accommodates the temperature detecting portion inside the protruding part. Further, by setting the length along the first axis of the protruding part to be less than or equal to 0.5 times the second inner diameter of the second flow channel part, it is possible to prevent the protruding part from excessively inhibiting the flow of a fluid in the first flow channel part and the second flow channel part.

In the fluid device according to one aspect of the present disclosure, a preferable configuration is such that the protruding part is formed in a circular cylindrical shape protruding along the second axis from an inner circumferential face of the coupling region, and an outer diameter of the protruding part is set to be greater than or equal to 0.1 times and less than or equal to 0.8 times an second inner diameter of the second flow channel part.

According to the fluid device of the above configuration, by setting the outer diameter of the protruding part to be greater than or equal to 0.1 times the second inner diameter of the second flow channel part, it is possible to sufficiently secure the inner diameter of the accommodation hole that accommodates the temperature detecting portion inside the protruding part. Further, by setting the outer diameter of the protruding part to be less than or equal to 0.8 times the second inner diameter of the second flow channel part, it is possible to prevent the protruding part from excessively inhibiting the flow of a fluid in the first flow channel part and the second flow channel part.

In the fluid device of the above configuration, a preferable form is such that a length along the second axis of the protruding part is set to be greater than or equal to 0.1 times and less than or equal to 0.5 times an inner diameter of the first flow channel part.

According to the fluid device of the above form, by setting the length along the second axis of the protruding part to be greater than or equal to 0.1 times the inner diameter of the first flow channel part, it is possible to sufficiently secure the length of the accommodation hole that accommodates the temperature detecting portion inside the protruding part. Further, by setting the length along the second axis of the protruding part to be less than or equal to 0.5 times the inner diameter of the first flow channel part, it is possible to prevent the protruding part from excessively inhibiting the flow of a fluid in the first flow channel part and the second flow channel part.

In the fluid device according to one form of the present disclosure, a preferable configuration is such that an angle at which the first axis and the second axis intersect is set to 90 degrees.

According to the fluid device of the above configuration, by setting the angle at which the first axis and the second axis intersect to be 90 degrees, it is possible to relatively easily perform the cutting process for forming the first flow channel part and the second flow channel part to the body formed of a resin material. Further, compared to a case where the angle at which the first axis and the second axis intersect is greater than 90 degrees, the body can be made more compact.

In the fluid device according to one aspect of the present disclosure, a preferable configuration is such that the temperature detecting portion is a thermocouple, and a contact point of the thermocouple is accommodated in the accommodation hole.

According to the fluid device of the above configuration, by accommodating a contact point of the thermocouple in the accommodation hole formed inside the protruding part, it is possible to suitably detect thermoelectromotive force transferred to the contact point via the protruding part and corresponding to the temperature of the fluid flowing through a coupling region.

According to the present disclosure, it is possible to provide a fluid device that can suitably determine the temperature of a fluid flowing through the center of a flow channel without direct contact of a temperature detecting portion with the fluid.

### BRIEF DESCRIPTION OF THE DRAWINGS

FIG. 1 is a longitudinal sectional view illustrating an isolation valve according to a first embodiment of the present disclosure.

FIG. 2 is a partial enlarged view of the portion A of the isolation valve illustrated in FIG. 1.

FIG. 3 is an arrow B-B sectional view of the isolation valve illustrated in FIG. 2.

FIG. 4 is a longitudinal sectional view illustrating an isolation valve according to a second embodiment of the present disclosure.

FIG. 5 is a partial enlarged view of the portion C of the isolation valve illustrated in FIG. 4.

FIG. 6 is a longitudinal sectional view illustrating an isolation valve according to a third embodiment of the present disclosure.

FIG. 7 is an arrow D-D sectional view of the isolation valve illustrated in FIG. 6.

FIG. 8 is a plan view of the isolation valve illustrated in FIG. 6.

FIG. 9 is a longitudinal sectional view illustrating an isolation valve according to a fourth embodiment of the present disclosure.

FIG. 10 is a longitudinal sectional view illustrating an isolation valve according to a fifth embodiment of the present disclosure.

### DETAILED DESCRIPTION

### First Embodiment

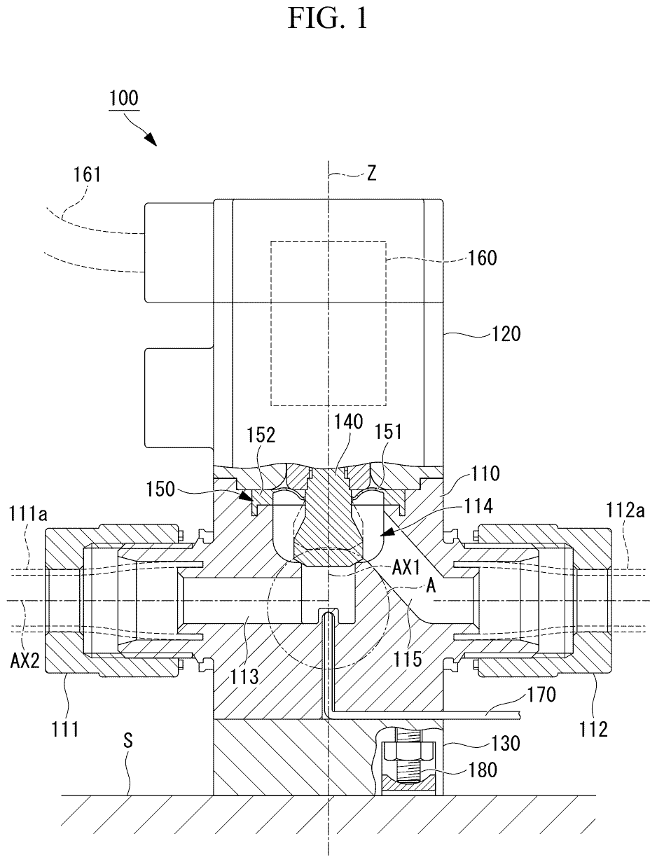

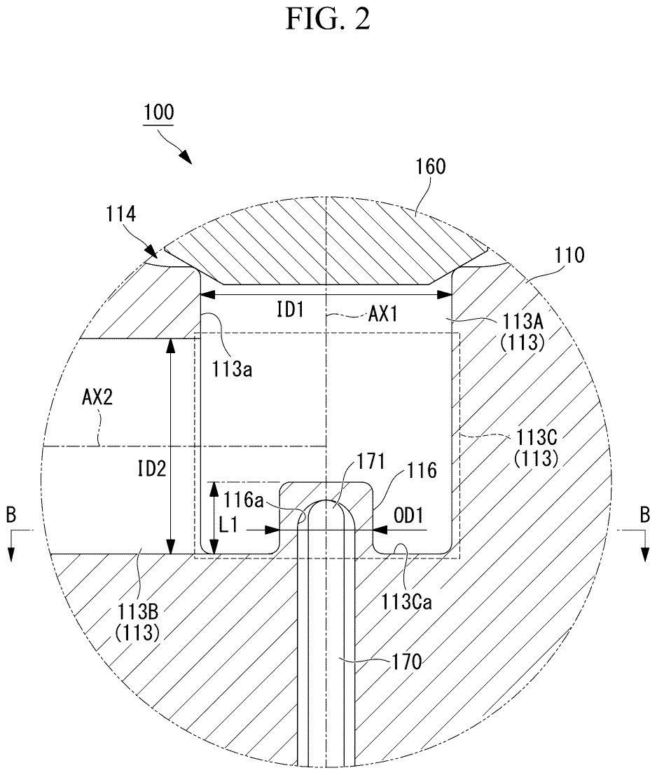

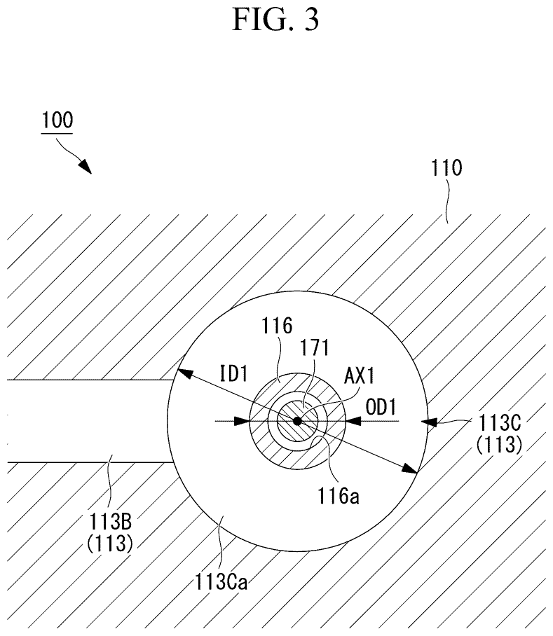

An isolation valve (fluid device) 100 according to a first embodiment of the present disclosure will be described below with reference to the drawings. The isolation valve 100 of the present embodiment is a fluid device installed in a pipe through which a fluid (a liquid such as a chemical solution and pure water) used in a semiconductor manufacturing apparatus or the like flows to flow therethrough. FIG. 1 is a longitudinal sectional view illustrating the isolation valve 100 according to the first embodiment of the present disclosure. FIG. 2 is a partial enlarged view of the portion A of the isolation valve 100 illustrated in FIG. 1. FIG. 3 is an arrow B-B sectional view of the isolation valve 100 illustrated in FIG. 2.

As illustrated in FIG. 1 and FIG. 2, the isolation valve 100 includes a body 110, an upper housing 120, a lower housing 130, a valve disc 140, a diaphragm unit 150, a motion mechanism 160, and a temperature detecting portion 170.

The body 110 is a member inside which a fluid flow channel (an inflow-side flow channel 113, a valve chamber 114, and an outflow-side flow channel 115 described later) that guides a fluid from an inlet port 111 to an outlet port 112 is formed. The body 110 is integrally formed of a fluororesin material.

A fluid flow channel formed inside the body 110 has the inflow-side flow channel 113, the valve chamber 114, and the outflow-side flow channel 115. The inflow-side flow channel 113 is a flow channel that guides the fluid flowing from the inflow-side pipe 111a to the valve chamber 114. The valve chamber 114 is a space that accommodates the valve disc 140 therein. The valve chamber 114 is a space in which the valve disc 140 is arranged, and the space communicates with the inflow-side flow channel 113 and the outflow-side flow channel 115 and is formed between the body 110 and the lower face of the diaphragm unit 150.

The outflow-side flow channel 115 is a flow channel that guides the fluid from the valve chamber 114 to the outflow-side pipe 112a. As illustrated in FIG. 2, a valve hole 113a to or from which the valve disc 140 moves closer or away along the axis Z is formed at the end on the valve chamber 114 side of the inflow-side flow channel 113.

The upper housing 120 is a member arranged above the body 110 and accommodating the diaphragm unit 150 and the motion mechanism 160 in a space formed between the body 110 and the upper housing 120. The lower housing 130 is a member arranged below the body 110 and installed to an installation face S.

As illustrated in FIG. 1, the upper housing 120 and the lower housing 130 are fastened by fastening bolts 180 with the body 110 being interposed therebetween, and thereby the body 110, the upper housing 120, and the lower housing 130 are integrated. The upper housing 120 and the lower housing 130 are integrated by, for example, four fastening bolts 180 arranged at positions at the same distance from the axis Z.

As illustrated in FIG. 1 and FIG. 2, the valve disc 140 is a member formed in a shaft-like shape extending along the axis (motion axis) Z and configured to move closer to or away from the valve hole 113a that guides a fluid from the inflow-side flow channel 113 to the valve chamber 114. The isolation valve 100 can be switched by the motion mechanism 160 between a closed state (a state indicated by dotted lines in FIG. 1) where the valve disc 140 is moved closer until coming into contact with the body 110 to block an inflow of a fluid from the valve hole 113a to the valve chamber 114 and an open state (a state indicated by solid lines in FIG. 1) where the valve disc 140 is moved away from the body 110.

As illustrated in FIG. 1, the diaphragm unit 150 is a member having a thin film part 151 and a base part 152. The thin film part 151 is coupled to the outer circumferential face of the valve disc 140 arranged in the valve chamber 114 and is formed annularly about the axis Z so as to isolate the valve chamber 114 including the valve disc 140 arranged therein from the space adjacent to the valve chamber 114. The base part 152 is coupled to the outer circumferential side of the thin film part 151 and formed annularly about the axis Z.

The diaphragm unit 150 is formed of a fluororesin material integrally with the valve disc 140. The thin film part 151 is formed annularly about the axis Z and formed in a thin-film shape with a thickness of 0.2 mm to 0.5 mm. The thin film part 151 has flexibility such that the thin film part 151 is deformed in accordance with the valve disc 140 moving along the axis Z.

The motion mechanism 160 is a mechanism that switches the valve disc 140 into a closed state or an open state. The motion mechanism 160 generates a driving force to move the valve disc 140 by compressed air supplied from a supply pipe 161 connected to a compressed air supply source (not illustrated).

The temperature detecting portion 170 is a device that determines the temperature of a fluid flowing through the inflow-side flow channel 113 of the body 110. The temperature detecting portion 170 determines, by a detecting element 171 accommodated in an accommodation hole 116a inside the protruding part 116 described later, the temperature of a fluid transferred from a fluid near the protruding part 116 to the protruding part 116. The temperature detecting portion 170 is a thermocouple, for example, and the detecting element 171 in the thermocouple is a contact point of a pair of metal wires formed of different metal materials. As the temperature detecting portion 170, a platinum resistance thermometer bulb, a thermistor, or the like may be employed.

The detecting element 171 is fixed by a thermal conductive adhesive injected into the accommodation hole 116a. By filling a space between the detecting element 171 and the accommodation hole 116a with a thermal conductive adhesive, it is possible to ensure a state where the temperature of a fluid flowing through the inflow-side flow channel 113 is transferred to the detecting element 171 via the protruding part 116.

Next, a configuration in which the detecting element 171 of the temperature detecting portion 170 are accommodated in the protruding part 116 of the body 110 will be described. As illustrated in FIG. 2, the inflow-side flow channel 113 has a first flow channel part 113A extending along a first axis AX1 with one end communicating with the valve chamber 114 and a second flow channel part 113B extending along a second axis AX2 with one end communicating with the inflow-side pipe 111a. As illustrated in FIG. 2, the first flow channel part 113A and the second flow channel part 113B are coupled to each other in the coupling region 113C. The first axis AX1 is an axis that matches the axis Z extending in the vertical direction. The second axis AX2 is an axis that intersects the first axis AX1 at an angle of 90 degrees.

As illustrated in FIG. 2 and FIG. 3, the protruding part 116 protruding along the first axis AX1 from the inner circumferential face 113Ca of a coupling region 113C is formed in the body 110. The accommodation hole 116a accommodating the detecting element 171 of the temperature detecting portion 170 is formed inside the protruding part 116. The protruding part 116 is formed in a circular cylindrical shape protruding along the first axis AX1 from the inner circumferential face 113Ca of the coupling region 113C.

As illustrated in FIG. 2 and FIG. 3, the outer diameter of the protruding part 116 is OD1, and the inner diameter of the first flow channel part 113A is ID1. For example, the outer diameter OD1 and the inner diameter (first inner diameter) ID1 are preferably set in accordance with Equation (1) below.

$$0.1 \times ID 1 ≦ OD 1 ≦ 0.8 \times ID 1 \qquad ( 1 )$$

As illustrated in FIG. 2, the length along the first axis AX1 of the protruding part 116 is L1, and the inner diameter of the second flow channel part 113B is ID2. For example, the length L1 and the inner diameter (second inner diameter) ID2 are preferably set in accordance with Equation (2) below.

$$0.1 \times ID 2 ≦ L 1 ≦ 0.5 \times ID 2 \qquad ( 2 )$$

The effects and advantages achieved by the isolation valve 100 of the present embodiment described above will be described.

The isolation valve 100 of the present embodiment includes: a body 110 having a valve chamber 114, an inflow-side flow channel 113, and an outflow-side flow channel 115 that are integrally formed of a resin material. One of the inflow-side flow channel 113 and the outflow-side flow channel 115 has a first flow channel part 113A extending along a first axis AX1 and a second flow channel part 113B extending along a second axis AX2 that intersects the first axis AX1. A protruding part 116 protruding along the first axis AX1 from an inner circumferential face 113Ca of the coupling region 113C in which the first flow channel part 113A and the second flow channel part 113B are coupled to each other is formed in the body. Further, the detecting element 171 of the temperature detecting portion 170 is accommodated in the accommodation hole 116a formed inside the protruding part 116. According to the isolation valve 100 of the present embodiment, since the temperature detecting portion 170 is accommodated inside the protruding part 116, the damage of the temperature detecting portion 170 that would otherwise be caused by direct contact of the temperature detecting portion 170 with the fluid can be inhibited. Further, since the protruding part 116 in which the temperature detecting portion 170 is accommodated protrudes along the first axis AX1 from the inner circumferential face 113Ca of the coupling region 113C, the temperature of a fluid flowing through the center of the first flow channel part 113A can be suitably determined.

According to the isolation valve 100 of the present embodiment, by setting the outer diameter OD1 of the protruding part 116 to be greater than or equal to 0.1 times the inner diameter ID1 of the first flow channel part 113A, it is possible to sufficiently secure the inner diameter of the accommodation hole 116a that accommodates the temperature detecting portion 170 inside the protruding part 116. Further, by setting the outer diameter OD1 of the protruding part 116 to be less than or equal to 0.8 times the inner diameter ID1 of the first flow channel part 113A, it is possible to prevent the protruding part 116 from excessively inhibiting the flow of a fluid in the first flow channel part 113A and the second flow channel part 113B.

According to the isolation valve 100 of the present embodiment, by setting the length L1 along the first axis AX1 of the protruding part 116 to be greater than or equal to 0.1 times the inner diameter ID2 of the second flow channel part 113B, it is possible to sufficiently secure the length L1 of the accommodation hole 116a that accommodates the temperature detecting portion 170 inside the protruding part 116. Further, by setting the length L1 along the first axis AX1 of the protruding part 116 to be less than or equal to 0.5 times the inner diameter ID2 of the second flow channel part 113B, it is possible to prevent the protruding part 116 from excessively inhibiting the flow of a fluid in the first flow channel part 113A and the second flow channel part 113B.

### Second Embodiment

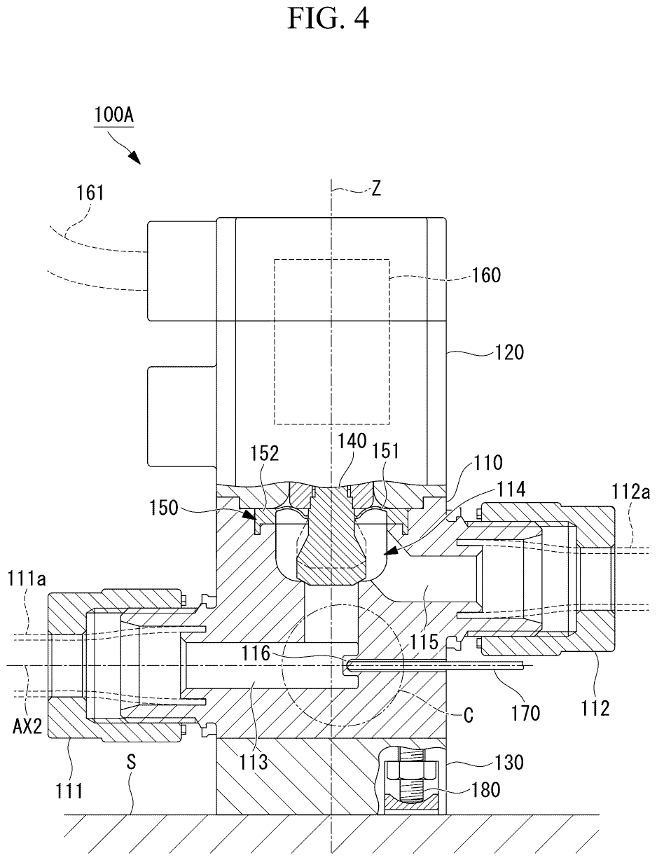

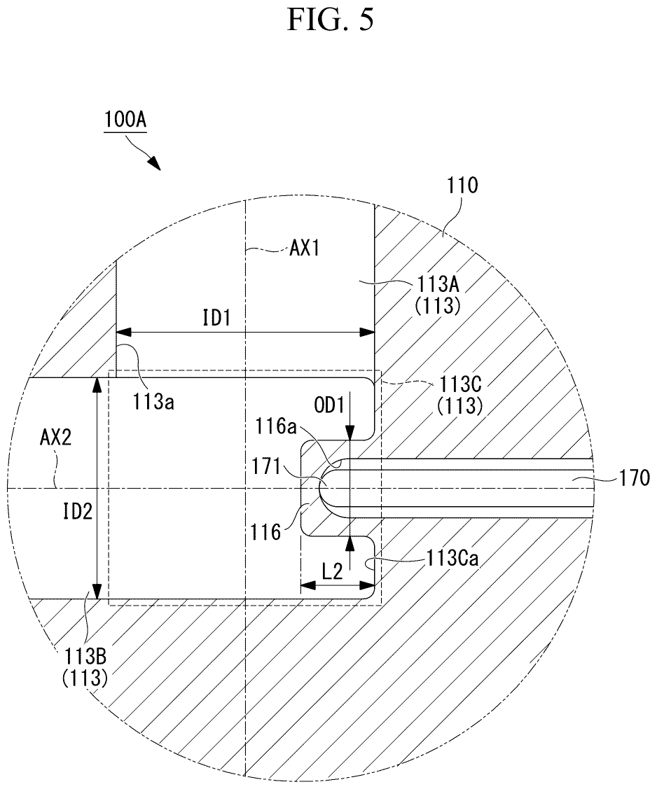

Next, an isolation valve 100A according to a second embodiment of the present disclosure will be described with reference to the drawings. Since the second embodiment is a modified example to the first embodiment, some description thereof will be omitted below as being the same as the first embodiment except where specifically described below. FIG. 4 is a longitudinal sectional view illustrating the isolation valve 100A according to the second embodiment of the present disclosure. FIG. 5 is a partial enlarged view of the portion C of the isolation valve 100A illustrated in FIG. 4.

In the isolation valve 100 of the first embodiment, the protruding part 116 protruding along the first axis AX1 from the inner circumferential face 113Ca of the coupling region 113C in which the first flow channel part 113A and the second flow channel part 113B are coupled to each other is formed in the body 110. In contrast, in the isolation valve 100A of the present embodiment, the protruding part 116 protruding along the second axis AX2 from the inner circumferential face 113Ca of the coupling region 113C in which the first flow channel part 113A and the second flow channel part 113B are coupled to each other is formed in the body 110.

As illustrated in FIG. 4 and FIG. 5, the inflow-side flow channel 113 has a first flow channel part 113A extending along a first axis AX1 with one end communicating with the valve chamber 114 and a second flow channel part 113B extending along a second axis AX2 with one end communicating with the inflow-side pipe 111a. As illustrated in FIG. 5, the first flow channel part 113A and the second flow channel part 113B are coupled to each other in the coupling region 113C. The first axis AX1 is an axis that matches the axis Z extending in the vertical direction. The second axis AX2 is an axis that intersects the first axis AX1 at an angle of 90 degrees.

As illustrated in FIG. 4 and FIG. 5, the protruding part 116 protruding along the second axis AX2 from the inner circumferential face 113Ca of a coupling region 113C is formed in the body 110. The accommodation hole 116a accommodating the detecting element 171 of the temperature detecting portion 170 is formed inside the protruding part 116. The protruding part 116 is formed in a circular cylindrical shape protruding along the second axis AX2 from the inner circumferential face 113Ca of the coupling region 113C.

As illustrated in FIG. 4 and FIG. 5, the outer diameter of the protruding part 116 is OD1, and the inner diameter of the second flow channel part 113B is ID2. For example, the outer diameter OD1 and the inner diameter ID2 are preferably set in accordance with Equation (3) below.

$$0.1 \times ID 2 ≦ OD 1 ≦ 0.8 \times ID 2 \qquad ( 3 )$$

As illustrated in FIG. 5, the length along the second axis AX2 of the protruding part 116 is L2, and the inner diameter of the first flow channel part 113A is ID1. For example, the length L2 and the inner diameter ID1 are preferably set in accordance with Equation (4) below.

$$0.1 \times ID 1 ≦ L 2 ≦ 0.5 \times ID 1 \qquad ( 4 )$$

The effects and advantages achieved by the isolation valve 100A of the present embodiment described above will be described.

According to the isolation valve 100A of the present embodiment, since the temperature detecting portion 170 is accommodated inside the protruding part 116, the damage of the temperature detecting portion 170 that would otherwise be caused by direct contact of the temperature detecting portion 170 with the fluid can be inhibited. Further, since the protruding part 116 in which the temperature detecting portion 170 is accommodated protrudes along the second axis AX2 from the inner circumferential face 113Ca of the coupling region 113C, the temperature of a fluid flowing through the center of the second flow channel part 113B can be suitably determined.

According to the isolation valve 100A of the present embodiment, by setting the outer diameter OD1 of the protruding part 116 to be greater than or equal to 0.1 times the inner diameter ID2 of the second flow channel part 113B, it is possible to sufficiently secure the inner diameter of the accommodation hole 116a that accommodates the temperature detecting portion 170 inside the protruding part 116. Further, by setting the outer diameter OD1 of the protruding part 116 to be less than or equal to 0.8 times the inner diameter ID2 of the second flow channel part 113B, it is possible to prevent the protruding part 116 from excessively inhibiting the flow of a fluid in the first flow channel part 113A and the second flow channel part 113B.

According to the isolation valve 100A of the present embodiment, by setting the length L2 along the second axis AX2 of the protruding part 116 to be greater than or equal to 0.1 times the inner diameter ID1 of the first flow channel part 113A, it is possible to sufficiently secure the length L2 of the accommodation hole 116a that accommodates the temperature detecting portion 170 inside the protruding part 116. Further, by setting the length L2 along the second axis AX2 of the protruding part 116 to be less than or equal to 0.5 times the inner diameter ID1 of the first flow channel part 113A, it is possible to prevent the protruding part 116 from excessively inhibiting the flow of a fluid in the first flow channel part 113A and the second flow channel part 113B.

### Third Embodiment

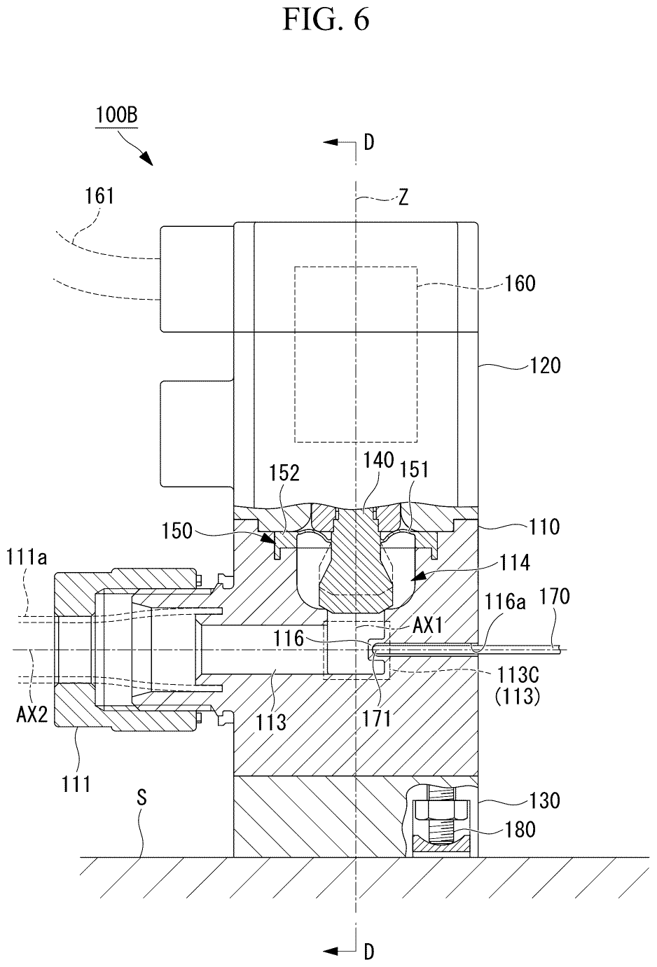

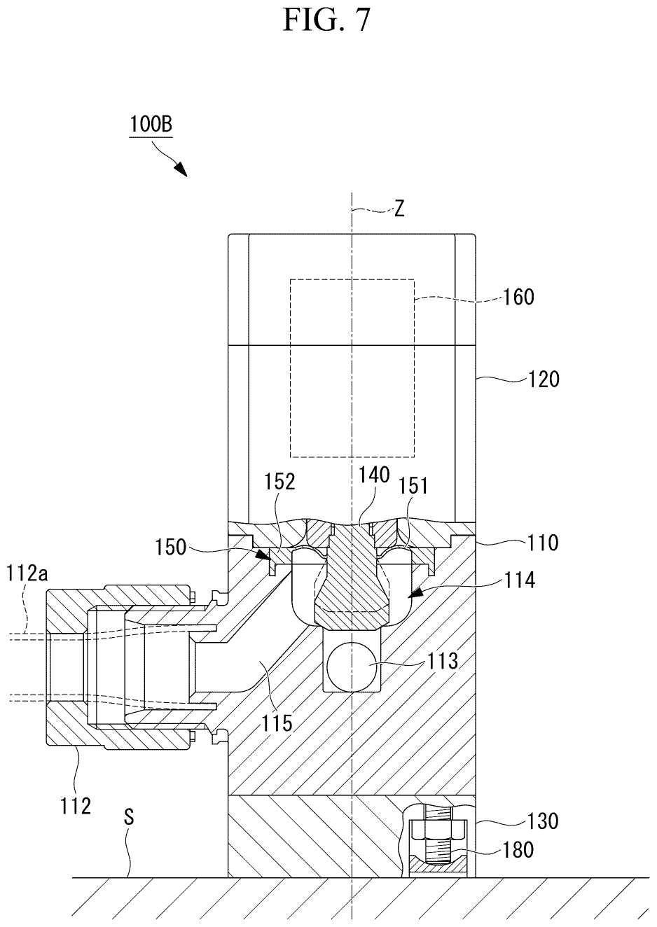

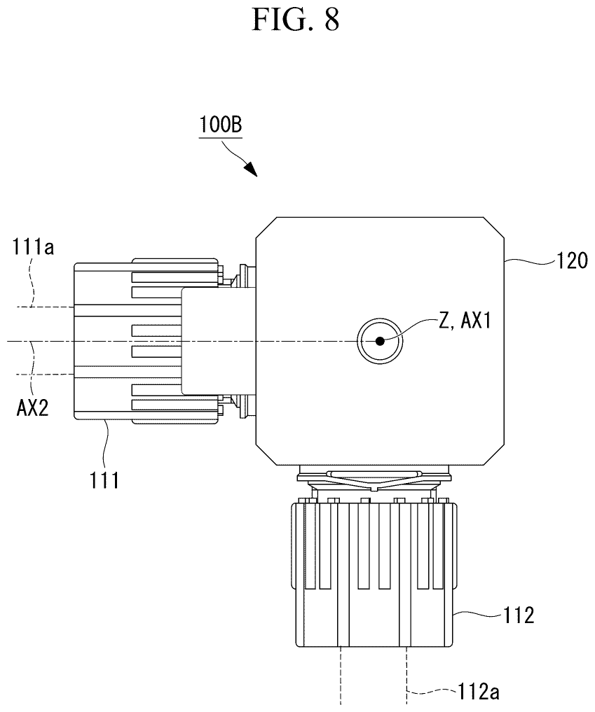

Next, an isolation valve 100B according to a third embodiment of the present disclosure will be described with reference to the drawings. Since the third embodiment is a modified example to the second embodiment, some description thereof will be omitted below as being the same as the second embodiment except where specifically described below. FIG. 6 is a longitudinal sectional view illustrating the isolation valve 100B according to the third embodiment of the present disclosure. FIG. 7 is an arrow D-D sectional view of the isolation valve 100B illustrated in FIG. 6. FIG. 8 is a plan view of the isolation valve 100B illustrated in FIG. 6.

In the isolation valve 100A of the second embodiment, the inlet port 111 and the outlet port 112 are arranged on the same straight line in planar view. In contrast, in the isolation valve 100B of the present embodiment, the inlet port 111 and the outlet port 112 are not arranged on the same straight line in planar view. In the isolation valve 100B of the present embodiment, the direction in which the inflow-side flow channel 113 extends and the direction in which the outflow-side flow channel 115 extends differ by 90 degrees in planar view.

As illustrated in FIG. 6, the protruding part 116 protruding along the second axis AX2 from the inner circumferential face of a coupling region 113C is formed in the body 110. The accommodation hole 116a accommodating the detecting element 171 of the temperature detecting portion 170 is formed inside the protruding part 116. The protruding part 116 is formed in a circular cylindrical shape protruding along the second axis AX2 from the inner circumferential face of the coupling region 113C.

As illustrated in FIG. 8, in the isolation valve 100B of the present embodiment, the inlet port 111 and the outlet port 112 are not arranged on the same straight line in planar view. As illustrated in FIG. 6 and FIG. 7, in the isolation valve 100B of the present embodiment, the direction in which the inflow-side flow channel 113 extends and the direction in which the outflow-side flow channel 115 extends differ by 90 degrees in planar view.

According to the isolation valve 100B of the present embodiment, since the direction in which the inflow-side flow channel 113 extends and the direction in which the outflow-side flow channel 115 extends differ by 90 degrees in planar view, it is possible to form the accommodation hole 116a extending linearly along the second axis AX2. Further, the height of the inlet port 111 and the height of the outlet port 112 with respect to the installation face S are the same, and this enables an operator to easily connect the inflow-side pipe 111a to the inlet port 111 and connect the outflow-side pipe 112a to the outlet port 112.

### Fourth Embodiment

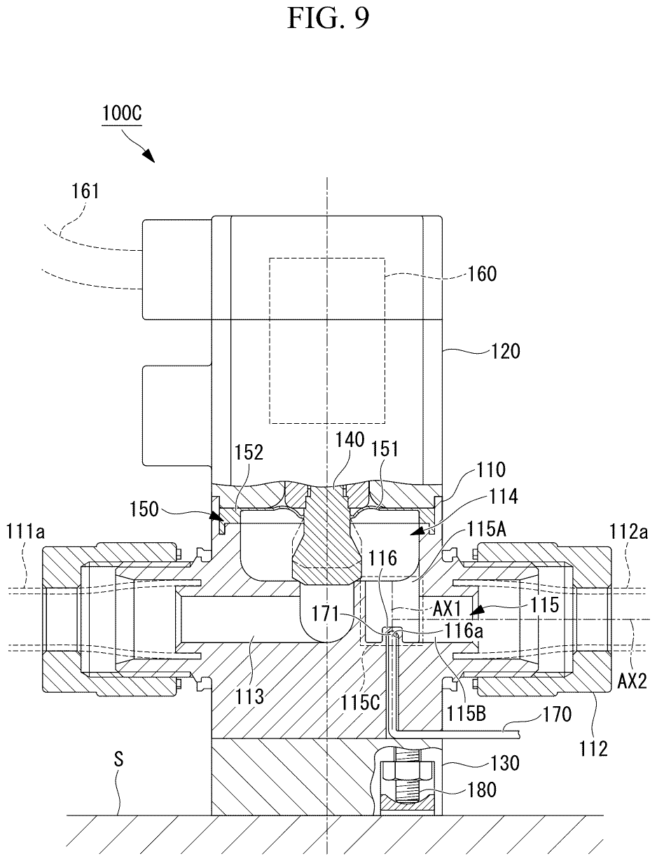

Next, an isolation valve 100C according to a fourth embodiment of the present disclosure will be described with reference to the drawings. Since the fourth embodiment is a modified example to the first embodiment, some description thereof will be omitted below as being the same as the first embodiment except where specifically described below. FIG. 9 is a longitudinal sectional view illustrating the isolation valve 100C according to the fourth embodiment of the present disclosure.

In the isolation valve 100 of the first embodiment, the protruding part 116 protruding along the first axis AX1 is formed in the coupling region 113C of the inflow-side flow channel 113, and the temperature detecting portion 170 is arranged inside the protruding part 116. In contrast, in the isolation valve 100C of the present embodiment, the protruding part 116 protruding along the first axis AX1 is formed in the coupling region 115C of the outflow-side flow channel 115 and the temperature detecting portion 170 is arranged inside the protruding part 116.

As illustrated in FIG. 9, the outflow-side flow channel 115 of the isolation valve 100C of the present embodiment has a first flow channel part 115A extending along a first axis AX1 with one end communicating with the valve chamber 114 and a second flow channel part 115B extending along a second axis AX2 with one end communicating with the outflow-side pipe 112a. As illustrated in FIG. 9, the first flow channel part 115A and the second flow channel part 115B are coupled to each other in the coupling region 115C.

As illustrated in FIG. 9, the protruding part 116 protruding along the first axis AX1 from the inner circumferential face of a coupling region 115C is formed in the body 110. The accommodation hole 116a accommodating the detecting element 171 of the temperature detecting portion 170 is formed inside the protruding part 116. The protruding part 116 is formed in a circular cylindrical shape protruding along the first axis AX1 from the inner circumferential face of the coupling region 115C.

According to the isolation valve 100C of the present embodiment, since the temperature detecting portion 170 is accommodated inside the protruding part 116, the damage of the temperature detecting portion 170 that would otherwise be caused by direct contact of the temperature detecting portion 170 with the fluid can be inhibited. Further, since the protruding part 116 in which the temperature detecting portion 170 is accommodated protrudes along the first axis AX1 from the inner circumferential face of the coupling region 115C, the temperature of a fluid flowing through the center of the first flow channel part 115A can be suitably determined.

### Fifth Embodiment

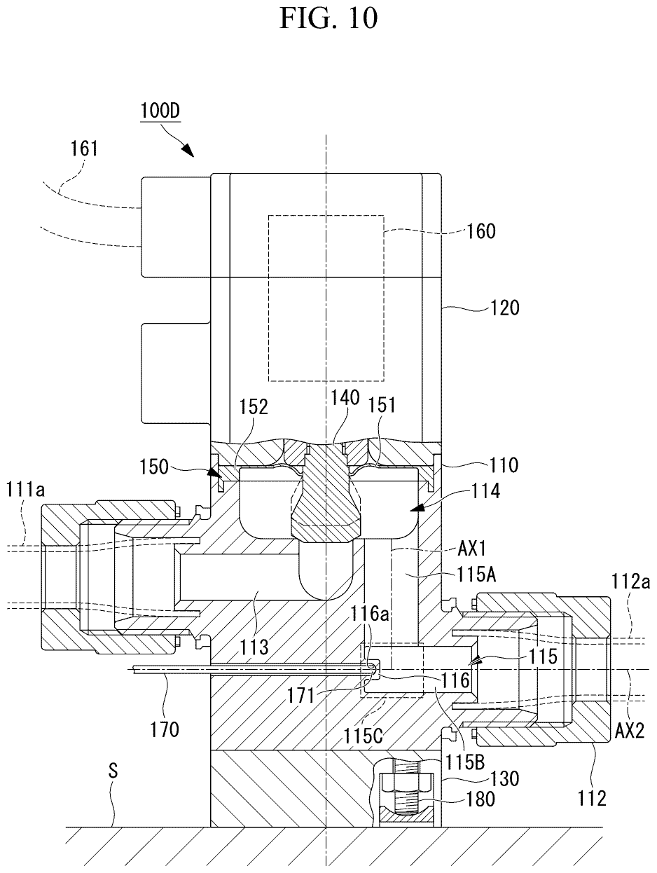

Next, an isolation valve 100D according to a fifth embodiment of the present disclosure will be described with reference to the drawings. Since the fifth embodiment is a modified example to the second embodiment, some description thereof will be omitted below as being the same as the second embodiment except where specifically described below. FIG. 10 is a longitudinal sectional view illustrating the isolation valve 100D according to the fifth embodiment of the present disclosure.

In the isolation valve 100A of the second embodiment, the protruding part 116 protruding along the second axis AX2 is formed in the coupling region 113C of the inflow-side flow channel 113, and the temperature detecting portion 170 is arranged inside the protruding part 116. In contrast, in the isolation valve 100D of the present embodiment, the protruding part 116 protruding along the second axis AX2 is formed in the coupling region 115C of the outflow-side flow channel 115 and the temperature detecting portion 170 is arranged inside the protruding part 116.

As illustrated in FIG. 10, the outflow-side flow channel 115 of the isolation valve 100D of the present embodiment has a first flow channel part 115A extending along a first axis AX1 with one end communicating with the valve chamber 114 and a second flow channel part 115B extending along a second axis AX2 with one end communicating with the outflow-side pipe 112a. As illustrated in FIG. 10, the first flow channel part 115A and the second flow channel part 115B are coupled to each other in the coupling region 115C.

As illustrated in FIG. 10, the protruding part 116 protruding along the second axis AX2 from the inner circumferential face of a coupling region 115C is formed in the body 110. The accommodation hole 116a accommodating the detecting element 171 of the temperature detecting portion 170 is formed inside the protruding part 116. The protruding part 116 is formed in a circular cylindrical shape protruding along the second axis AX2 from the inner circumferential face of the coupling region 115C.

According to the isolation valve 100D of the present embodiment, since the temperature detecting portion 170 is accommodated inside the protruding part 116, the damage of the temperature detecting portion 170 that would otherwise be caused by direct contact of the temperature detecting portion 170 with the fluid can be inhibited. Further, since the protruding part 116 in which the temperature detecting portion 170 is accommodated protrudes along the second axis AX2 from the inner circumferential face of the coupling region 115C, the temperature of a fluid flowing through the center of the second flow channel part 115B can be suitably determined.

### Other Embodiments

Although the isolation valve 100 has been described as the fluid device in the above description, the present disclosure may be applied to other fluid devices. For example, the present disclosure may be applied to other fluid devices such as a flow rate adjusting device that adjusts the length of insertion of a needle valve into a valve hole to adjust the flow rate of a fluid.

Although the flow channel indicated by the reference numeral 113 is the inflow-side flow channel and the flow channel indicated by the reference numeral 115 is the outflow-side flow channel in the embodiments described above, other forms may be applied. For example, the flow channel indicated by the reference numeral 113 may be the outflow-side flow channel and the flow channel indicated by the reference numeral 115 may be the inflow-side flow channel.

What is claimed is:

1. A fluid device comprising:
a valve disc formed in a shaft-like shape extending along a motion axis and configured to be movable along the motion axis;
a body having a valve chamber, an inflow-side flow channel, and an outflow-side flow channel that are integrally formed of a resin material, the valve chamber accommodating the valve disc, the inflow-side flow channel being configured to guide a fluid flowing from an inflow-side pipe to the valve chamber, and the outflow-side flow channel being configured to guide a fluid from the valve chamber to an outflow-side pipe; and
a temperature detecting portion configured to determine a temperature of a fluid flowing through the body,
wherein one of the inflow-side flow channel and the outflow-side flow channel has a first flow channel part extending along a first axis with one end communicating with the valve chamber and a second flow channel part extending along a second axis that intersects the first axis with one end communicating with one of the inflow-side pipe and the outflow-side pipe,
wherein the first flow channel part and the second flow channel part are coupled to each other in a coupling region,
wherein a protruding part protruding along the first axis or the second axis from an inner circumferential face of the coupling region is formed in the body, and
wherein an accommodation hole accommodating the temperature detecting portion is formed inside the protruding part.

2. The fluid device according to claim 1,
wherein the protruding part is formed in a circular cylindrical shape protruding along the first axis from the inner circumferential face of the coupling region, and
wherein an outer diameter of the protruding part is set to be greater than or equal to 0.1 times and less than or equal to 0.8 times a first inner diameter of the first flow channel part.

3. The fluid device according to claim 2, wherein a length along the first axis of the protruding part is set to be greater than or equal to 0.1 times and less than or equal to 0.5 times a second inner diameter of the second flow channel part.

4. The fluid device according to claim 1,
wherein the protruding part is formed in a circular cylindrical shape protruding along the second axis from the inner circumferential face of the coupling region, and
wherein an outer diameter of the protruding part is set to be greater than or equal to 0.1 times and less than or equal to 0.8 times an inner diameter of the second flow channel part.

5. The fluid device according to claim 4, wherein a length along the second axis of the protruding part is set to be greater than or equal to 0.1 times and less than or equal to 0.5 times an inner diameter of the first flow channel part.

6. The fluid device according to claim 1, wherein an angle at which the first axis and the second axis intersect is set to 90 degrees.

7. The fluid device according to claim 1,
wherein the temperature detecting portion is a thermocouple, and
wherein a contact point of the thermocouple is accommodated in the accommodation hole.
